(19) United States
(12) Patent Application Publication
(10) Pub. No.: US 2006/0243711 A1
(43) Pub. Date: Nov. 2, 2006

(54) System and method for aligning a wafer processing system in a laser marking system

(76) Inventors: Robert Paradis, Haverhill, MA (US); Keith Ballantyne, Reading, MA (US); Gary Paolucci, North Reading, MA (US); Oliver Streich, Waltham, MA (US)

Correspondence Address: GAUTHIER & CONNORS, LLP, 225 FRANKLIN STREET, BOSTON, MA, 02110, US

(21) Appl. No.: 11/118,456

(22) Filed: Apr. 29, 2005

(51) Int. Cl. B23K 26/00

(52) U.S. Cl. 219/121.68; 219/121.69

(57) ABSTRACT

A system is disclosed for determining laser processing performance in a back side wafer marking system. The system includes a laser marking system for creating pattern marks on a back side of a target wafer, and a detection system for detecting the pattern marks through a front side of the target wafer. The target wafer includes a thickness, an index of refraction and two substantially planar surfaces such that the apparent focal area of the detection system through the target wafer is substantially close to the front side of the target wafer.

### BACKGROUND

The invention generally relates to semiconductor substrate processing systems and relates in particular to measuring mark placement accuracy in back side wafer marking systems.

Laser marking systems for semiconductor wafers may be employed, for example, in semiconductor wafer processing systems that provide for the relative positioning and control of one or more semiconductor wafers in at least an x direction and a y direction such that laser marking is typically performed in the x-y plane, the laser impinging the wafer generally along a z direction. The laser marking system may remain stationary, therefore, while a wafer stage is moved in the x and y directions. The wafer may be about 200 mm to 300 mm in diameter.

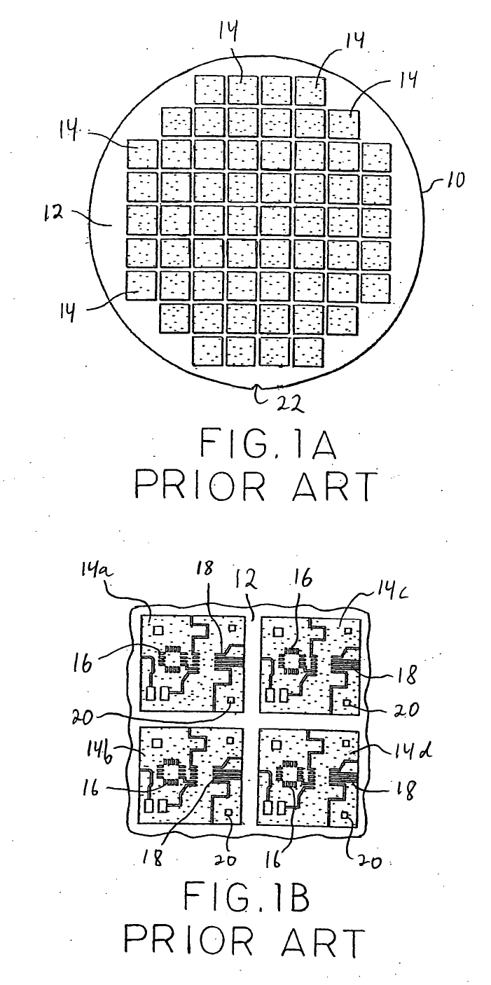

As shown in FIGS. 1A and 1B, a semiconductor wafer 10 may include a front side 12 on which a plurality of circuits 14a, 14b, 14c and 14d may be formed. The wafer 10 may later be diced into a plurality of individual circuits 14a-14d following fabrication of the circuit elements 16 and 18 on each circuit 14a-14d. Four such circuits are shown in FIG. 1B. The semiconductor wafer 10 may also include a notch 22 to facilitate the identification of the proper orientation of the wafer 10 within the processing equipment.

In certain applications, it is desirable to also add an identification marking on either the front side or a back side of each circuit. Such marking is typically performed using a laser, and this laser marking may be used to identify not only the circuit but also manufacturing information in connection with each circuit, orientation information regarding the circuit, or performance data regarding the circuit.

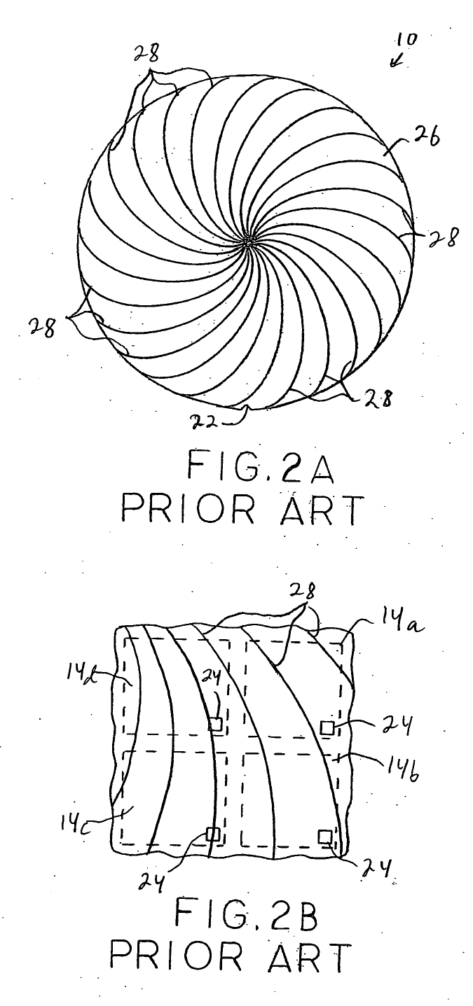

In applications in which the front side 12 of the semiconductor wafer 10 includes circuits 14a-14d that are very dense with elements and conductor paths, it is sometimes desirable to provide identification markings on the back side of the semiconductor wafer. For example, FIG. 2A shows the back side 16 of the semiconductor wafer 10, and FIG. 2B shows markings 24 on the back side of each circuit 14a-14d. The marking information may include a wide variety of text or other symbolic information, and is represented in FIG. 2B as a square 20 in the lower right corner of the front side of each circuit 14a-14d. Such a marking may be easily machine readable if the contrast of the marked versus un-marked regions is relatively high.

The back side of most conventional semiconductor wafers, however, is typically ground to reduce the thickness of the semiconductor wafer so that thinner circuits 14 may be provided. Such grinding to reduce the thickness of the wafer is typically performed in a circular motion, and this causes a large number of very fine grooves 28, for example, in the general shape of a pinwheel to be formed on the surface of the back side 26 of the semiconductor wafer 10. This further complicates the automated detection of any indicia.

One method of laser marking of the wafer 10 is to form a pattern into the surface of the back side of the wafer. Another method of laser marking of the back side of a semiconductor wafer involves using a laser to provide a molten trace on the back side surface, to thereby remove the relief surface provided by the grooves. Such a trace mark may have a very small depth of relief, of for example, 0 to 1.0 microns, and typically about 0.5 microns. For example, U.S. Pat. No. 6,261,919, the disclosure of which is hereby incorporated by reference, discloses a system and method for forming a molten trace on the back side of a semiconductor wafer for purposes of marking. See also U.S. Published Patent Applications Nos. 2004/00600910, 2004/0031779 and 2004/0144760, the disclosures of which are hereby incorporated by reference, which each disclose high speed, laser-based marking systems and methods for Chip Scale Packages (CSP) for producing machine readable marks on workpieces and semiconductor devices with reduced subsurface damage produced thereby.

The indicia laser marked by such techniques may be any type of graphical mark, but are typically alphanumeric characters, pin indicators such as filled circles, circuit feature indication marks and chip orientation marks such as chevrons. Smaller die such as, for example, 0.1 by 0.2 mm die may be marked with a dot or orientation mark, while larger die, for example 2.5 mm by 20 mm may be marked with alpha numeric characters.

For CSP marking, the wafer is held in a wafer chuck that allows laser marking of indicia on the backside of die sites across the wafer. High accuracy marking is achieved by marking indicia in a scan field smaller than the size of the wafer, for example, over an 80 mm square field. To cover all of the sites to be marked with indicia on the back of the wafer, the wafer is stepped with a stage relative to marking field.

In certain applications it would be desirable for a laser marking and wafer processing system to be able to correlate images from the front side of a wafer with images from the back side of a wafer. Correlating such top and bottom inspections provides highly accurate testing of the position of each marking on each circuit prior to dicing. Performing such a correlation requires a back side detection system that can read the back side of a wafer while it is being handled, as well as a front side detection system of the front side of a wafer.

A conventional method of determining accuracy is to mark a test wafer and measure the marks. In order to determine marked location relative to the front side dice, a wafer must be inspected from both sides with excellent registration front to back. Conventional large area inspection techniques such as a gantry type measuring video microscope require flipping a wafer with precise fixturing to maintain registration. Not only is this a cumbersome task, but wafers are thin, fragile and prone to breakage. Improved methods are needed that allow accurate single sided inspection of robust test wafers.

There is a need, therefore, for a laser marking and processing system that provides automated correlation of the front and back sides of the wafer.

### SUMMARY

A system is disclosed for determining laser processing performance in a back side wafer marking system. The system includes a laser marking system for creating pattern marks on a back side of a target wafer, and a detection system for detecting the pattern marks through a front side of the target wafer. The target wafer includes a thickness, an index of refraction and two substantially planar surfaces such that the apparent focal area of the detection system through the target wafer is substantially close to the front side of the target wafer.

### BRIEF DESCRIPTION OF THE ILLUSTRATED EMBODIMENTS

The following detailed description may be further understood with reference to the accompanying drawings in which:

FIG. 1A shows an illustrative diagrammatic view of a front side of a semiconductor wafer on which a plurality of circuits may be formed in accordance with the prior art, and FIG. 1B shows an illustrative diagrammatic view of a portion of the view shown in FIG. 1A including a subset of the plurality of circuits;

FIG. 2A shows an illustrative diagrammatic view of a back side of a semiconductor wafer on which a plurality of circuits may be formed in accordance with the prior art, and FIG. 2B shows an illustrative diagrammatic view of a portion of the view shown in FIG. 2A including a marking on the back side of a subset of the plurality of circuits;

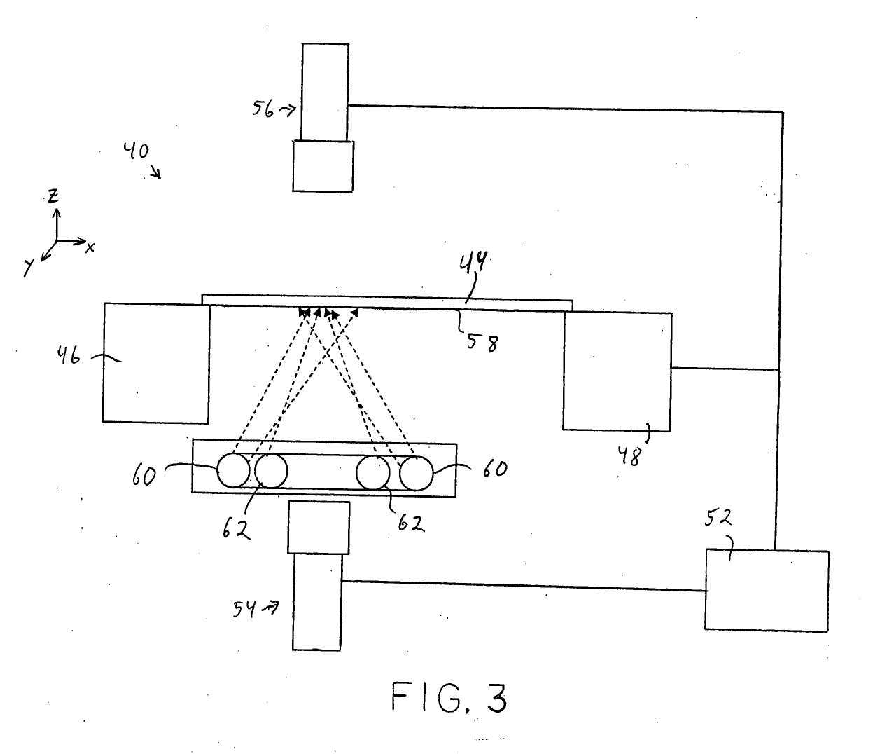

FIG. 3 shows an illustrative diagrammatic view of a laser marking and imaging system employing a target wafer in accordance with an embodiment of the present invention;

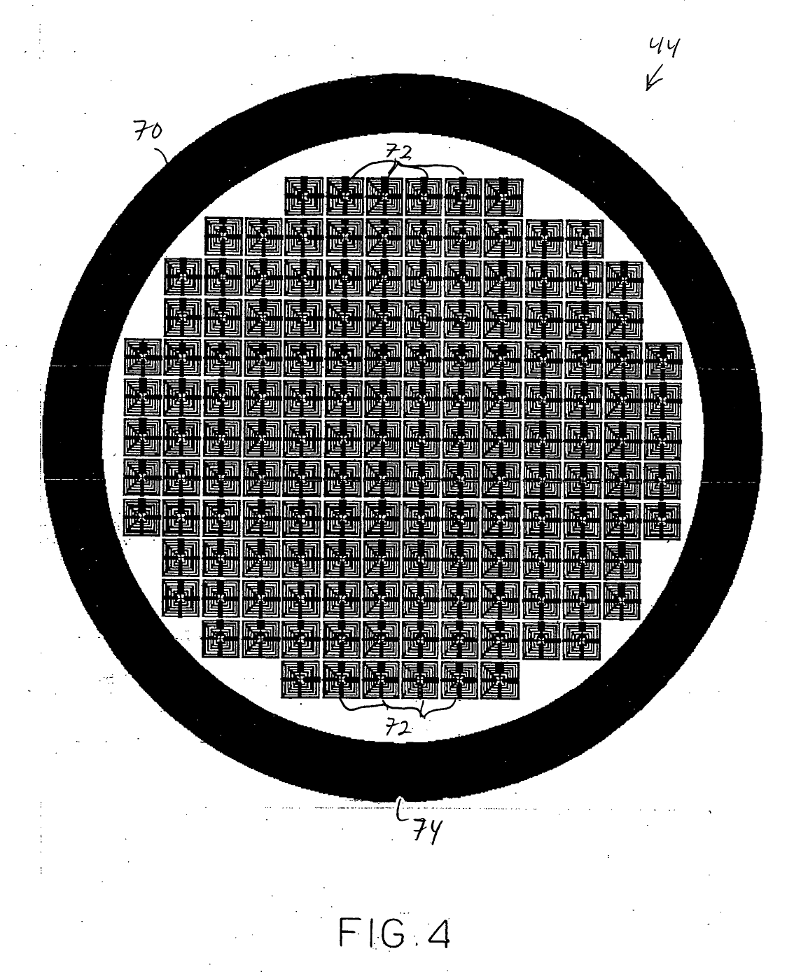

FIG. 4 shows an illustrative diagrammatic top view of the target wafer of FIG. 3;

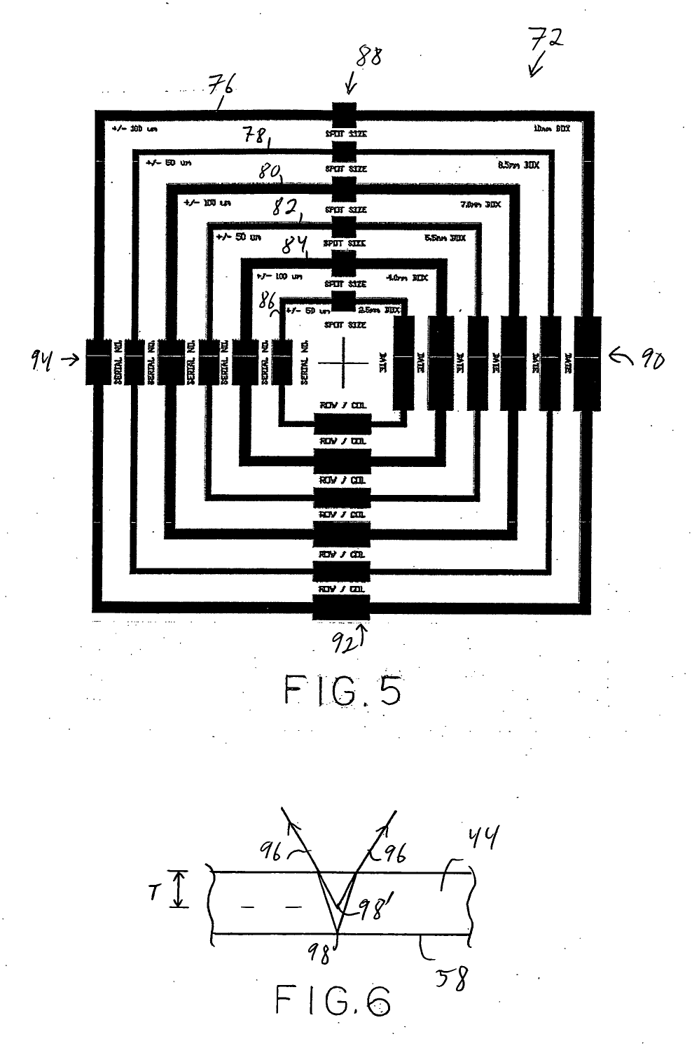

FIG. 5 shows an illustrative diagrammatic top view of a portion of the transparent target wafer of FIG. 3; and

FIG. 6 shows an illustrative diagrammatic partial side sectional view of the target wafer of FIG. 3.

The drawings are show for illustrative purposes only and are not to scale.

### DETAILED DESCRIPTION OF THE ILLUSTRATED EMBODIMENTS

In accordance with an embodiment of the present invention, a test wafer made from a transparent substrate is patterned on at least one side. The chip scale markig system with the patterned surface of the test wafer loaded down is aligned to the pattern from the top side by viewing the pattern through the substrate. The pattern is then marked from the bottom on the wafer back side. The mark penetrates the patterning material so that the mark may be visible from both sides of the test wafer. The transparent wafer is inspected to determine system accuracy by finding the mark position relative to measured pattern bands. The invention provides a front and back side correlation system for a wafer marking and inspection assembly. The invention, therefore, provides camera calibration.

As shown in FIG. 3, a laser correlation system 40 in accordance with an embodiment of the invention includes a wafer target 44. The wafer target is generally transparent with opaque lines formed thereon, and is further shown in FIG. 4. The correlation system 40 further includes a laser marking system 54 for forming indicia on the back side of the wafer target 44, a positioning system including chucks 46 and 48 for positioning the wafer target 44 relative to the marking system 54, and a system controller 52 for coordinating operation of the marking system 54, and a front side inspection system 56. The system 40 may also provide an illumination system for a back side inspection system that includes a pair of concentric fluorescent ring lights 60 and 62.

The target wafer 44 may include a plurality of target cells or dice 72, each of which may correspond to a circuit to be diced from a particular wafer. The peripheral edge of the wafer may include a solid distinct border 70, and the target wafer may include an orientation notch 74. In order to align a 200 mm wafer in a CSP marker, the top side dice are viewed with a camera that can be positioned accurately over the wafer. Preferably, the camera uses a telecentric lens to minimize the effect of defocus errors on position and the locations of the dice are determined.

Each dice 72 includes a plurality of concentric squares 76, 78, 80, 82, 84 and 86 as shown in FIG. 5, and notes regarding each test may be written into notation boxes associated with each square as generally indicated at 88, 90, 92 and 94.

During use, the back side of the target wafer is marked based on the location of the dice and the system calibration. The markings are intended to draw lines between one or more of the box edges. For example, the marking system may draw a box consisting of four straight lines between the target edges of the boxes 76 and 78. Because the width of the space that separates the edges of the boxes 76 and 78 is twice the tolerance for the system (e.g., twice 50 microns), any misalignment that is outside of tolerance will become readily apparent. Information regarding the test, such as spot size, date, serial number and row/column information may be recorded in the associated note fields.

Marking is, therefore, performed on the back side, and imaging analysis may be performed from the front side of the target wafer. The target wafer is preferably transparent and may be formed, for example, of glass. The patterning on the target wafer may be printed on the back side using, for example chrome. A 15 mm wide plated annulus with a hard wafer edge notch allows for pre-align the transparent wafer with conventionally wafer prealigners.

The pattern may be viewed through the transparent substrate for alignment from the top side. In particular, the top side camera used for wafer fine alignment is focused on the normal wafer top side. The alignment pattern is displaced from the top to the bottom of the test wafer. At the same time, the position of the pattern 98 is offset from its actual position on the back side 58 of the target wafer 44 due to the optical properties of the transparent substrate to an apparent position 98′ as shown in FIG. 6. For a wafer of thickness T having an index of refraction n, the virtual height H of the pattern when viewed through the wafer is offset according to H=T×(1−1/n). Therefore, when the thickness of the test wafer is increased the offset is increased. The thickness T of the test wafer may be increased to so that the height of the pattern image offset toward the top side plane of a wafer to be marked is increased thereby reducing defocusing of the image. Increasing the thickness of the test wafer also makes the test wafer more mechanically robust. In practice, test wafers are 0.7 mm thick glass and the image is offset about 0.24 mm corresponding to top of a 0.24 mm thick wafer. With this test wafer and a 0.4 mm wafer, the defocus is to 0.16 mm, within an acceptable defocus range.

The aligned test wafer is marked with character strings or other indicia on the pattern to record marking data such as serial number, date stamp, spot size, row and column numbers or other data. The pattern may include measured bands, and lines or characters are marked at nominal positions within the bands. Marking accuracy is determined by inspecting marks made in the band portions of the test pattern. When the mark is contained within the band, system accuracy is confirmed. The band geometry is coded in software so that different bands can be selected and marked sequentially at any time according to predetermined software routines.

Marking the transparent test wafer is also beneficial for system testing and calibration. Marking at edges of a test wafer may be used to check system stage travel across the wafer; however the marking field may not get to all edges of the wafer processing field. Since that pattern of the test wafer is approximately in the focal plane of both the top and bottom sides of the wafer, top and bottom camera scales can be calibrated using the test wafer pattern. The pattern may include features such as squares used for both alignment and calibration or may include industry standard calibration patterns used for machine vision system calibration. Illumination may include front lighting or back lighting of the pattern on the transparent test wafer.

The accordance with an embodiment, therefore, the invention provides a method of determining laser processing performance characteristics in a backside wafer processing system that involves forming and image of a surface of a transparent substrate having a thickness, an index of refraction and two substantially planar surfaces, a first surface located at a laser processing plane and patterned with reference features, wherein the patterned surface is suitable for marking and is imaged through the transmitting substrate from the second surface side of the substrate, and wherein the image of the patterned surface appears shifted by a height according to the thickness and the index of refraction, the apparent image height corresponding to the thickness of a wafer to be processed, and obtaining information from the image and relating the information to one of camera scale, mark position, and stage position.

In accordance with another embodiment, the invention provides a method of determining laser processing performance characteristics in a backside wafer processing system having laser processing plane that involves placing a first patterned surface of a transparent substrate in the laser processing plane, the substrate having a thickness, an index of refraction, and two substantially planar surfaces, the patterned surface patterned with reference features and features suitable for marking, forming a top side image of the patterned surface through the transmitting substrate from the second surface side of the substrate, wherein the image of the patterned surface appears shifted by a height according to the thickness and the index of refraction, the apparent image height corresponding to the thickness of a wafer to be processed, and determining at least one position of a pattern feature from the top side image, aligning the marking field to a field of pattern features based on the position of the determined position, forming a laser mark at a predetermined location on the patterned surface at the laser processing plane, and obtaining information from the laser mark relating to one of mark position within the marking field, mark field position within the wafer, serialization data, date stamp data, row and column data, and a runtime sequence.

In accordance with a further embodiment, the invention provides a method of determining laser processing performance characteristics in a backside wafer processing system having a laser processing plane that involves placing a first patterned surface of a transparent substrate in the laser processing plane, the patterned surface patterned with reference features and features suitable for marking, determining at least one position of a pattern feature corresponding to a top side image of a wafer to be processed, aligning the marking field to a field of pattern features based on the at least one determined position, forming a laser mark at a predetermined location on the patterned surface, and obtaining information from the laser mark relating to one of mark position within the marking field, mark field position within the wafer, serialization data, date stamp data, and row and column data, and a runtime sequence.

Those skilled in the art will appreciate that numerous modifications and variations may be made to the above disclosed embodiment without departing from the spirit and scope of the invention.

What is claimed is:

1. A system for determining laser processing performance in a back side wafer marking system, said system comprising:
a laser marking system for creating reference marks on a back side of a wafer; and
a detection system for detecting reference features through a front side of a target wafer, said target wafer including a thickness, an index of refraction and two substantially planar surfaces such that the apparent focal area of the detection system through the target wafer is substantially close to the front side of the target wafer.

2. The system as claimed in claim 1, wherein said target wafer includes markable reference features on the back side of the target wafer.

3. The system as claimed in claim 1, wherein said target wafer includes a plurality of repeated patterns over a substantial portion of the target wafer.

4. The system as claimed in claim 1, wherein said target wafer includes markable lines having line widths of substantially similar scale as a tolerance of the marking system.

5. The system as claimed in claim 1, wherein said target wafer is formed of glass and the reference features are formed of chrome.

6. The system as claimed in claim 1, wherein said target wafer includes notation areas in which notes regarding each test may be recorded on the target wafer by the laser marking system.

7. A system for determining laser processing performance in a back side wafer processing system, said system comprising:
a laser marking system for creating marks in the area of a laser processing plane; and
a target wafer with a thickness, an index of refraction and two substantially planar surfaces, said target wafer further including a first surface located at the laser processing plane and patterned with reference features, wherein the patterned surface is suitable for marking and is imaged through the transmitting substrate from the second surface side of the substrate, and wherein the image of the patterned surface appears shifted by an apparent height according to the thickness and the index of refraction, the apparent image height corresponding to the thickness of a wafer to be processed.

8. The system as claimed in claim 7, wherein said target wafer is marked on a first side and imaged from a second opposite side.

9. The system as claimed in claim 7, wherein said target wafer includes a plurality of repeated patterns over a substantial portion of the target wafer.

10. The system as claimed in claim 7, wherein said target wafer includes lines that are mutually spaced from one another by a substantially similar distance.

11. The system as claimed in claim 7, wherein said target wafer is formed of glass and the reference features are formed of chrome.

12. The system as claimed in claim 7, wherein said target wafer includes notation areas in which notes regarding each test may be recorded on the target wafer by the laser marking system.

13. A method of determining laser processing performance in a back side wafer marking system, said method comprising the steps of:
creating pattern marks on a back side of a target wafer; and
detecting reference features through a front side of the target wafer, said target wafer including a thickness, an index of refraction and two substantially planar surfaces such that the apparent focal area of the detection system through the target wafer is substantially close to the front side of a wafer to be processed.

14. The method as claimed in claim 13, wherein said target wafer includes reference features on the back side of the target wafer.

15. The method as claimed in claim 13, wherein said target wafer includes a plurality of repeated patterns over a substantial portion of the target wafer.

16. The method as claimed in claim 13, wherein said target wafer includes lines that are mutually spaced from one another by a substantially similar distance.

17. The method as claimed in claim 13, wherein said target wafer is formed of glass and the reference features are formed of chrome.

18. The method as claimed in claim 13, wherein said target wafer includes notation areas in which notes regarding each test may be recorded on the target wafer by the laser marking system.
